(19) United States
(12) Patent Application Publication
(10) Pub. No.: US 2003/0193499 A1
(43) Pub. Date: Oct. 16, 2003

(54) Object-oriented three-dimensional polygons for the surface modeling of civil engineering objects

(76) Inventor: Bo Gao, Delta (CA)

Correspondence Address: Bo Gao, 7596 - 114 Street, Delta, BC, V4C 5H4, CA

(21) Appl. No.: 10/123,853

(22) Filed: Apr. 16, 2002

(51) Int. Cl. G06T 17/00

(52) U.S. Cl. 345/420

(57) ABSTRACT

The present invention provides a method to define, represent, store and manage the geometry of three-dimensional surfaces of civil engineering objects using object-oriented three-dimensional polygons, the two-dimensional polygons (plane projection of three-dimensional polygons) with object-oriented dots (DOTs) that are placed along the two-dimensional polygons to define elevations and vertical alignments of the three-dimensional polygons. The DOTs contain data and “methods” in an object-oriented CAD environment. The method provides a more intuitive and effective design framework for better visualization, management and integration of civil engineering design.

### CROSS-REFERENCE TO RELATED APPLICATIONS

Not Applicable.

### STATEMENT REGARDING FEDERAL SPONSORED RESEARCH OR DEVELOPMENT

Not Applicable.

### REFERENCE TO A MICROFICHE APPENDIX

Not Applicable.

### BACKGROUND OF THE INVENTION

In order to provide background information, reference is made to a number of patents and publications as follows:

Publications:

“Civil Engineering Reference Manual”, ISBN 1888577401.

“Civil Engineering Handbook”, ISBN 0849389534.

U.S. Patent

“System of Relational Entities for Object-Oriented Computer-Aided Geometric Design”, U.S. Pat. No. 5,627,949, May 6, 1997.

“Modeling of Surfaces Employing Polygon Stripe”, U.S. Pat. No. 5,561,749, Oct. 1, 1996.

“Method for Modifying a Geometric Object and Computer Aided Design System”, U.S. Pat. No. 5,615,319, Mar. 25, 1997.

The present invention related to a method of defining, representing, storing and managing the geometry of three-dimensional surfaces in a data structure for computer-aided design (CAD) of civil engineering facilities. Highway, freeway, interchange, railroad, airport, street, intersection, subdivision, building site, parking lot, reservoir, dam, landfill are some examples of civil engineering facilities.

The design of civil engineering facilities mainly involves two types of surfaces, original surface of existing ground and design surface of finished ground. The original surface of existing ground is commonly modeled and approximated by the Triangulated Irregular Network from a set of topographic survey points based on topographic survey principles.

The geometric definitions of three-dimensional design surfaces of finished ground of civil engineering facilities are essential for the design and construction of civil engineering projects; for example, the finished ground of pavement and embankment could be represented by a three-dimensional design surface.

FIG. 1 shows design surface of a segment of roadway. In civil engineering design, the geometry of roadway surface is commonly defined by three characteristics, a horizontal alignment with stationing (on the earth surface plane), a vertical alignment (perpendicular to earth surface plane) along the horizontal alignment, and cross-section templates associated with the horizontal and vertical alignments. The design is commonly presented by plans showing plane layout with horizontal alignments, profiles (vertical sections along horizontal alignments) with vertical alignments, and cross-sections (series of vertical sections perpendicular to horizontal alignments at certain stations), see FIG. 2, FIG. 3, and FIG. 4 for examples. The most of the roadway design standards and criteria are developed and depicted in terms of these characteristics, such as minimum radius of horizontal curves for horizontal alignments, minimum length of vertical curves (commonly parabolic curves) for vertical alignments, the cross-slope or super-elevation rates for cross sections, and so on. The conventional template-based CAD programs for civil engineering design, such as commercial software developed by Autodesk Inc., Eagle Point Software, Bentley System, use the similar data structure that define, store and manage the geometry of design surfaces by defining and storing horizontal alignments with different names, then defining and storing vertical alignments and cross sections for each horizontal alignment.

A few perspectives of this conventional template-based platform are cumbersome to designers and don't reflect the engineers' intuitive thinking process. The template-based system is effective in defining a linear segment of roadway surface with uniform or regular cross-sections, but not effective in defining and managing the non-linear features of design surfaces, such as intersections, interchanges. In the template-based CAD system, horizontal alignments, vertical alignments and cross-sections are commonly shown and handled separately, which make it awkward for engineers to visualize and manage the design concept. The engineers need significant reminiscence, imagination and experience to be able to visualize the three-dimensional surfaces and spatial relationships of civil engineering facilities through their individual and separate horizontal alignments, vertical alignments and cross-sections.

Besides, design surfaces of certain civil engineering facilities, such as building sites, parking lots, landfill, reservoirs, are not linear systems. Design surfaces of these facilities are commonly defined by finished ground contours and spot elevations. It is difficult to directly relate the contours and spot elevations to design standards for design evaluation and manipulation.

Generally, a natural way to design a civil engineering facility is to sketch on plane view for the evaluation of functional design issues, explore different design alternatives and constitute concept layout plan, then explore and constitute vertical design and cross-sections design, add more and more design details, and optimized the design to final completion. Besides conventional template-based procedure, a more intuitive and efficient design platform is needed to define and handle the design object for better design visualization, management and integration.

### BRIEF SUMMARY OF THE INVENTION

The three-dimensional design surfaces of finished ground are key elements in geometric definition and design of civil engineering facilities (objects); for example, the finished ground of pavement and embankment could be represented by a three-dimensional design surface.

An objective of the present invention is to provide a method to define, represent, store and manage the geometry of three-dimensional surfaces of civil engineering objects in an object-oriented CAD environment.

Another objective of the present invention is to utilize the said method and provide a more intuitive and effective design framework for better design visualization, management and integration.

The present invention provides a method to define, represent, store and manage the geometry of three-dimensional surfaces of civil engineering objects. In a preferred aspect of the present invention, the geometry of three-dimensional surfaces of civil engineering objects are defined and represented by intersecting three-dimensional polygons. The surfaces are intersected along the shared lines and curves that polygons are consist of. The way in which the surfaces are formed within each polygon would depend on the type of engineering objects and follow certain engineering principles. In most cases, the surfaces are formed by linearly interpolating between two sides of three-dimensional boundary lines or curves of polygons, which commonly represent cross-slope of the surfaces.

In the present aspect, these said three-dimensional polygons are defined and represented by object-oriented three-dimensional polygons that comprise two-dimensional polygons (plane projection of three-dimensional polygons) and object-oriented dots (DOTs). The two-dimensional polygons define horizontal alignment and layout of the three-dimensional polygons, and object-oriented dots (DOTs) are placed along the two-dimensional polygons to define the vertical alignment of the three-dimensional polygons. If the vertical alignments are comprised of tangents with grade breaks, the DOTs containing the locations and elevations of grade breaks would be able to define the vertical alignments. If the parabolic vertical curves are used in profile design, the DOTs would also need to contain the length or other parameter of the vertical curves to define the vertical alignments.

In the present aspect, the DOTs could contain the “methods” that define the behaviors of individual DOT and relationships among DOTs in an object-oriented CAD environment. This feature could be used to design the cross-slope, super-elevation and grading plane, and to establish the continuity or calculating relationships among different horizontal and vertical alignments. The polygons could also be treated as object and contain the “methods” that defines the behaviors of these polygons, such as materials and structures beneath the surface, or how the thee-dimensional surfaces are formed by the interpolation from three-dimensional polygons.

In another aspect of the present invention, object-oriented three-dimensional polygons of present invention could be used to establish an intuitive, intelligent and informational design framework for better visualization, management and integration of design process.

### BRIEF DESCRIPTION OF THE DRAWINGS

FIG. 1 shows finished ground surface and engineering characteristics of a segment of roadway.

FIG. 2 illustrates how the geometry of the roadway surface is defined by horizontal alignment in conventional template-based procedure.

FIG. 3 illustrates how the geometry of the roadway surface is defined by vertical alignment in conventional template-based procedure.

FIG. 4 illustrates how the geometry of the roadway surface is defined by cross-section template in conventional template-based procedure.

Fig, 5 illustrates how the geometry of the roadway surface is defined and represented by three-dimensional polygons according to a preferred embodiment of the present invention.

FIG. 6 illustrates how the said three-dimensional polygons are defined and represented with object-oriented three-dimensional polygons according to this preferred embodiment of the present invention.

FIG. 7 illustrates an example of application of object-oriented three-dimensional polygons in interchange design in one embodiment.

FIG. 8 illustrates an example of application of object-oriented three-dimensional polygons in subdivision design in this embodiment.

### DETAILED DESCRIPTION OF THE INVENTION

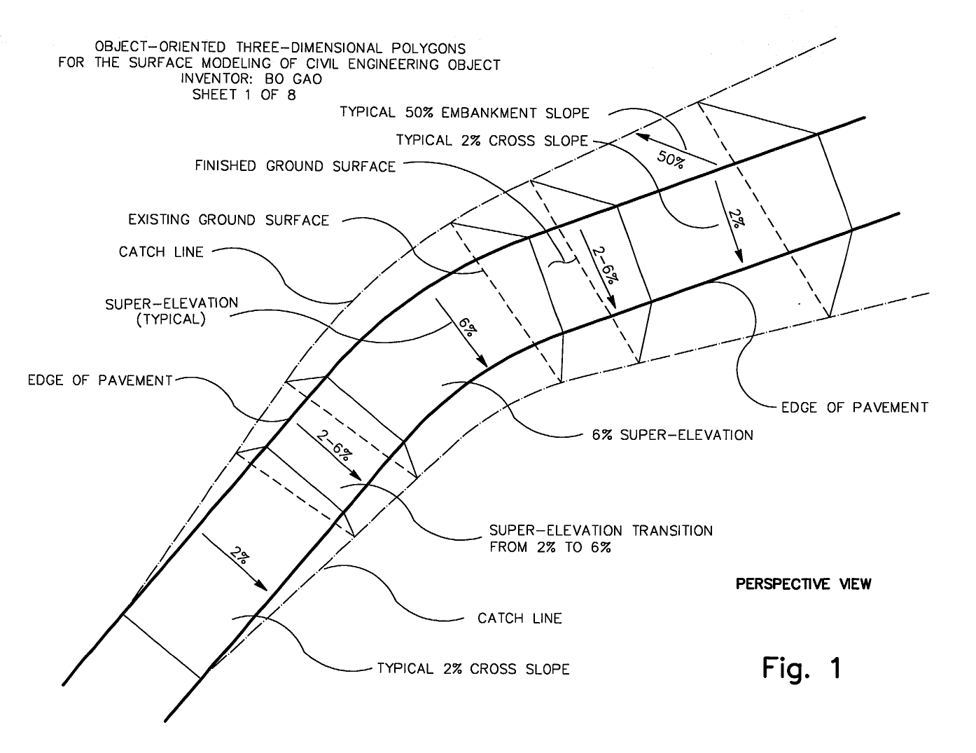

FIG. 1 shows perspective view of a segment of roadway pavement and embankment comprising of horizontal curve (circular curve) and tangents, vertical curve (parabolic curve) and tangents, cross-section slope and embankment slope, super-elevation and transitions, and catch lines (daylight lines where embankments intersect with existing ground).

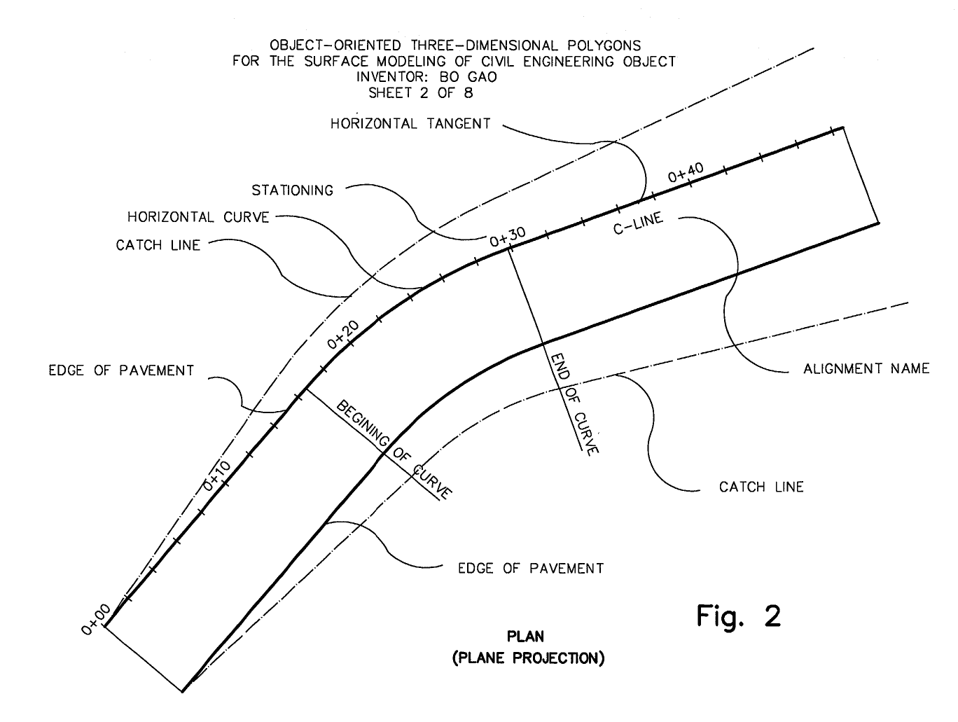

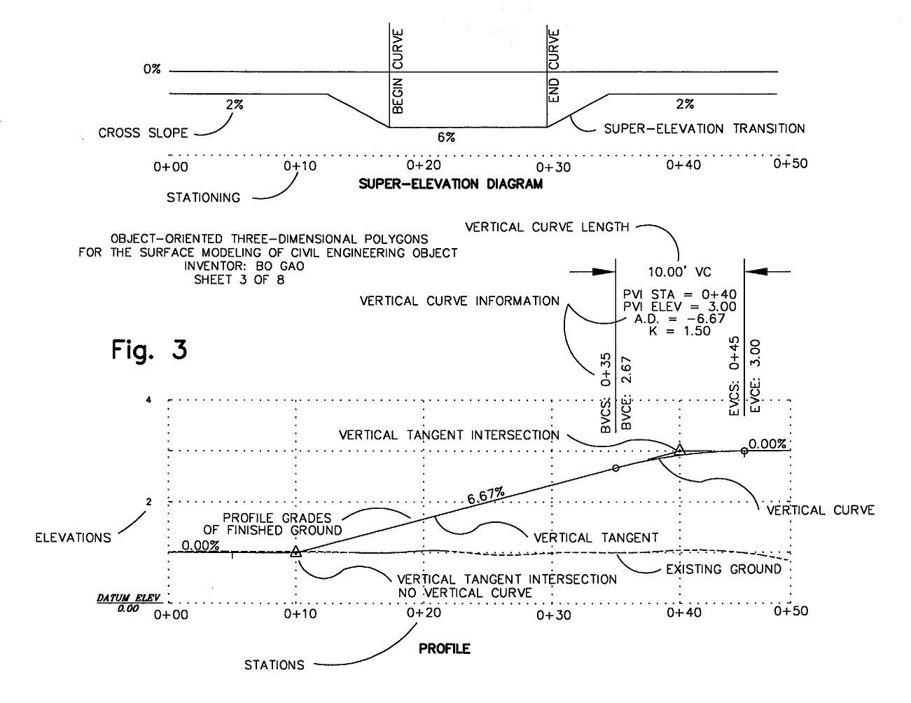

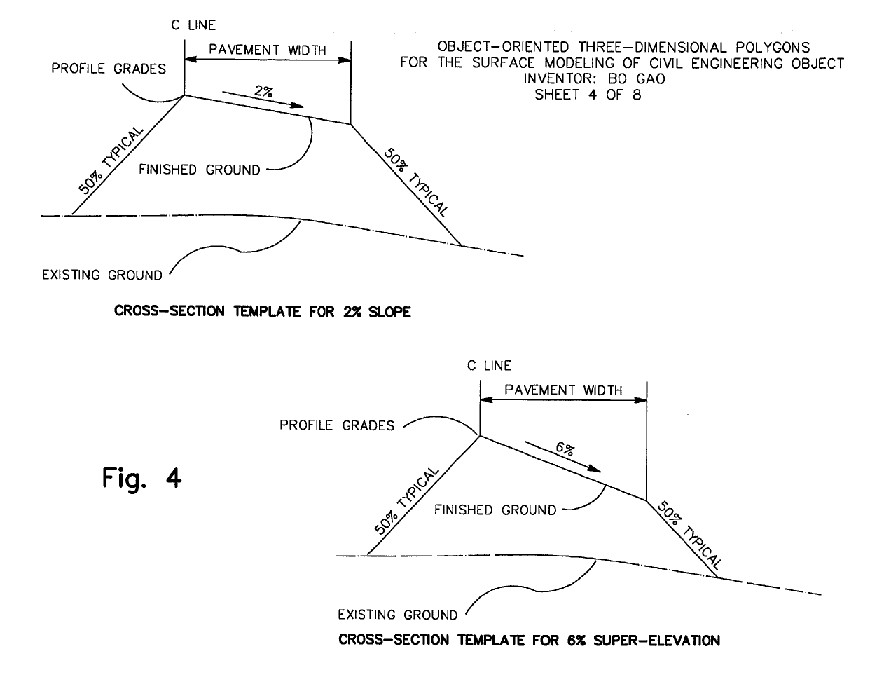

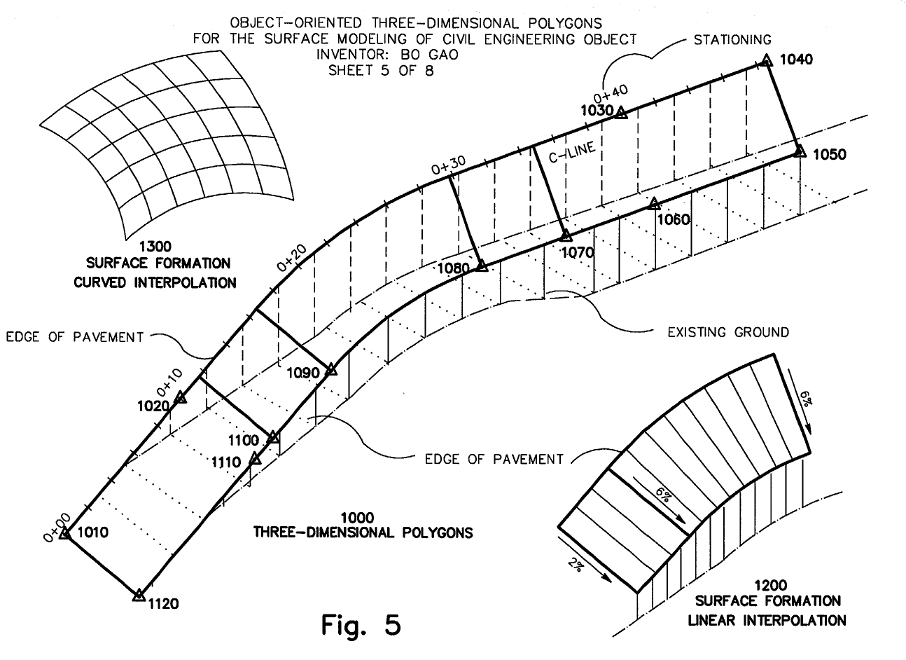

FIG. 2, FIG. 3, and FIG. 4 illustrate how the geometry of the roadway surface shown in FIG. 1 is defined with conventional template-based procedure. FIG. 2 shows plan layout (plane projection) of the roadway surface containing edge of pavement, catch line, and horizontal alignment (at left-edge of the pavement) with alignment name, stationing and curve information. FIG. 3 shows the profile section along the horizontal alignment defined in FIG. 2, containing existing ground profile, finished ground profile (vertical curve and tangents), and super-elevation diagram. FIG. 4 shows cross-section templates that are used to define roadway width, cross-slope and super-elevation, together with the horizontal alignment and profile grades defined in FIG. 2 and FIG. 3. In conventional template-based procedure, the plan, profile and cross sections are jointly used to define and represent the geometry of civil engineering objects, and most computer software for civil engineering design also use the similar approach.

Beyond the conventional template-based procedure, the present invention provides an additional method to define, represent, store and manage the geometry of three-dimensional surfaces of civil engineering objects. In a preferred embodiment of the present invention, the geometry of three-dimensional surfaces of civil engineering objects are defined and represented by intersecting three-dimensional polygons, and the way in which the surfaces are formed within each polygon would depend on the type of engineering objects and follow certain engineering principles. In the present embodiment, the three-dimensional polygons are defined and represented by object-oriented three-dimensional polygons, and the said object-oriented three-dimensional polygons are defined and represented by two-dimensional polygons plane projection of the three-dimensional polygons) that define horizontal alignment and layout of the three-dimensional polygons, and object-oriented dots (DOTs) that are placed along the two-dimensional polygons to define the vertical alignment of the three-dimensional polygons.

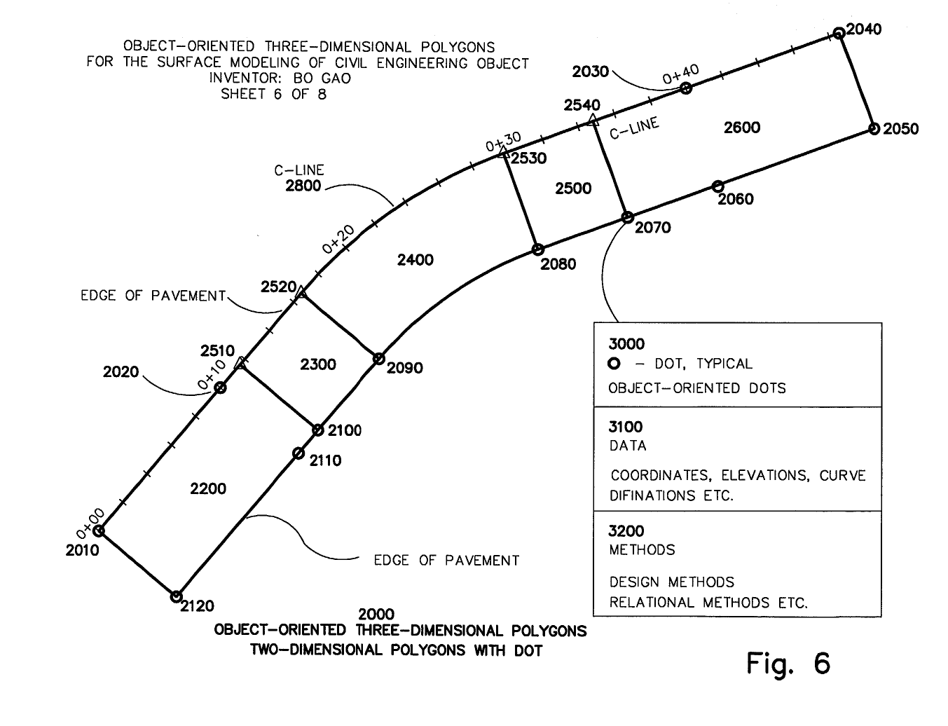

In the present embodiment, FIG. 5 and FIG. 6 illustrate how pavement portion of the finished ground surface for the roadway segment shown in FIG. 1 is defined and represented by object-oriented three-dimensional polygons. FIG. 5 shows how the pavement surface is defined by the three-dimensional polygons; the surface within each polygon is formed through linear lateral interpolations shown under “Surface Formation, Linear Interpolation” 1200. Other methods for surface interpolation within the polygons, such as curved interpolation shown under “Surface Formation, Curved Interpolation” 1300, could also be used for other conditions such as intersections. The triangles delineate the control points of the surface geometry, with triangles 1010, 1040, 1050, 1120 delineating the beginning and end of the roadway segment, triangles 1020, 1030 locating the vertical tangent intersections, and triangles 1060, 1070, 1080, 1090, 1100, 1110 representing beginnings and ends of super-elevation transitions. These control points are the candidate spots for the placement of DOTs.

In the present embodiment, FIG. 6 shows DOT apparatus and how the three-dimensional polygons shown in FIG. 5 are defined by object-oriented three-dimensional polygons. The DOT apparatus 3000 could include data 3100 and “methods” 3200, the data 3100 could contain coordinates, elevations, curve definition and other information, and “methods” 3200 could include the “design methods” that are established based on the engineering principals and design criteria to regulate how the engineering objects behave, and the “relational methods” that define how the DOTs are related to each other according to design concept. One of the main functions of these DOTs is for elevations design, to store control locations, elevations and vertical curve information, and “methods” that regulate elevation relationships among DOTs and perform vertical curve calculations. The design information in a DOT could be modified, and the design information of other related DOTs would be updated automatically based on the “relational methods” specified by the designer. The “methods” could also be contained in other design objects.

In the present embodiment, as shown in FIG. 6, the object-oriented three-dimensional polygons 2000 include two-dimensional polygons 2200, 2300, 2400, 2500 and 2600, and a group of object-oriented dots (DOTs) 2010, 2020, 2030, 2040, 2050, 2060, 2070, 2080, 2090, 2100, 2110 and 2120. The two-dimensional polygons are the plane projection of the three-dimensional polygons, and are constructed of lines (tangents) and curves to define the horizontal alignments and plan layout of the pavement surface. The group of DOTs are placed along these two-dimensional polygons to define and represent the elevations and vertical alignments of the three-dimensional polygons. The DOT could contain both data and methods, in this implementation example, DOTs 2010, 2040 would contain coordinates and elevation data conforming to adjacent segments of roadway, DOTs 2020, 2030 would contain coordinates (or stationing) and elevation data for vertical tangent intersections, DOT 2030 would contain additional vertical curve data and “methods38 that define and perform calculation for the vertical curve. The way in which the vertical curves are defined would depend on the type of engineering object and subject to certain engineering principles, and parabolic curves are used in most cases. The DOTs 2050, 2060, 2070, 2080, 2090, 2100, 2110, 2120 would contain the stations and offsets from the horizontal alignment 2800 (it's a civil engineering method to define the location of a point by station and offset), the cross-slope/super-elevation data, and the “methods” to calculate the elevations according to the offsets and slopes (for example, offset multiply slope equal to elevation difference between two DOTs 2040 and 2050) and control-line elevations at locations 2040, 2030, 2540, 2530, 2520, 2510, 2020, 2010 (elevations at 2510, 2520, 2530 and 2540 are calculated through elevations and curve information at 2020 and 2030). The DOT could also contain other data and “methods” based on engineering circumstance. The elevations at any point of the three-dimensional surface could be calculated through interpolation from data contained in two-dimensional polygons and DOTs based on type of objects and engineering principles. The three-dimensional surface could be defined, represented, stored and managed by two-dimensional polygons with DOTs, the object-oriented three-dimensional polygons.

In one embodiment of the present invention, the object-oriented three-dimensional polygons of present invention could be used to establish an intuitive, intelligent and informational design framework for better visualization, management and integration of design process.

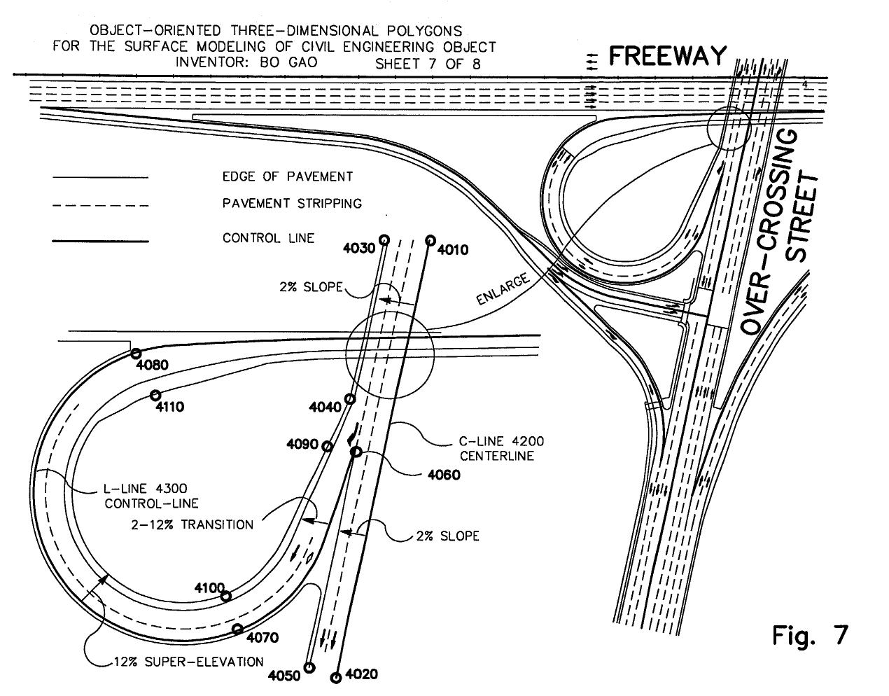

In the present embodiment, FIG. 7 shows one quadrant of an over-crossing interchange. The numerous horizontal alignments, profiles and cross-section templates would be needed to define the geometry of the interchange. Taking the exit from the street to the loop ramp as example, it is fairly awkward to define the surface geometry for exit taper segment with templates because of variable sections. By using object-oriented three-dimensional polygons of present invention, the designer could first create two-dimensional plane layout, then place DOTs 4010, 4020 to define the centerline profile of the over-crossing street, place DOTs 4030, 4040, 4050 to define pavement edge elevations by relating to street centerline elevations, place DOT 4060 by relating to street centerline elevations and place DOTs 4070, 4080 to define loop control-line profile, place DOTs 4090, 4100, 4110 to define pavement edge elevations by relating to loop control-line elevations. If the designer needs to adjust the over-crossing street elevations, he only needs to adjust elevations in DOTs 4010, 4020, and other elevations will be adjusted according to the “methods” stored in these DOTs. Other design functions could also incorporated into the process.

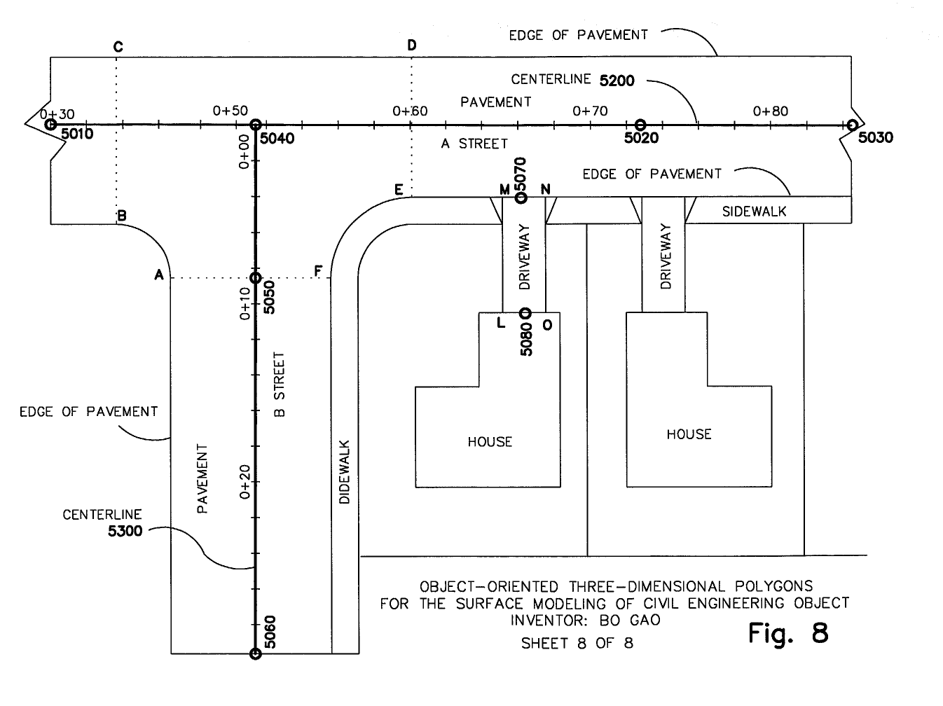

In the present embodiment, FIG. 8 shows how an intuitive design process could be implemented by using object-oriented three-dimensional polygons of present invention. The site is in a comer of “T” intersection of a residential development project. The designer could first consider the design requirements and user's preference, and propose the plan layout (two-dimensional polygons). Each two-dimensional polygons could also be considered as a object and contain both data and “methods”, for example, polygon ABCDEF outlines the intersection area and may contain a “method” for curved interpolation of surface formation or pavement structure information, polygon LMNO outlines the driveway area and may contain concrete paving design, surface finishing pattern and so on. For elevations design, designer could place DOTs 5010, 5020, 5030 along centerline 5200 to define the profile for A street, then place DOTs 5040, 5050, 5060 along centerline 5300 to define B street profile (elevations at Dot 5040 is dependant and to be interpolated between DOTs 5010 and 5020, and elevation at DOT 5050 is dependent on intersection grading design), and place DOTs along edge of pavement by relating to centerline profiles (not shown for this example). DOTs 5070 and 5080 could be placed to define building pad elevation, elevation at DOT 5070 is related to centerline profile, pad elevation at DOT 5080 could be related and calculated from DOT 5070 based on driveway slope requirement contained in “methods”, similar design approach could be used at all driveways and houses. If the designer needs to adjust grading design, he only needs to adjust street centerline elevations, and other elevations, including street edge elevations and building pad elevations, will be updated accordingly.

Various design fictions, including generating profile and cross-sections along specific alignment from the object-oriented three-dimensional polygons model, could be developed and included in CAD software that use the present invention.

The objective-oriented three-dimensional polygons could be used as design frameworks for the design of various civil engineering objects. One of the design framework may include the step of: developing the two-dimensional polygons to define and represent the plan layout and horizontal alignments of the engineering objects; placing the DOTs to define the elevations and vertical alignments of the engineering objects; establishing and specify the design data and the “methods” for the DOTs based on engineering principles and design concept; performing design calculations, analysis and modifications to the final completion, and producing engineering plans and documentations.

I claim:

1. A method to define, represent, store and manage the geometry of three-dimensional surfaces of civil engineering objects comprising:
Defining and representing the three-dimensional surfaces with intersecting three-dimensional polygons.
Defining and representing the said three-dimensional polygons with object-oriented three-dimensional polygons.

2. The method according to claim 1, wherein the geometry of three-dimensional surfaces are defined and represented by the intersecting three-dimensional polygons, and the surface formation method, the way in which the surfaces are formed and interpolated within each polygon would depend on the type of engineering objects and follow certain engineering principles.

3. The method according to claim 2, wherein the surface formation methods comprising:
Linear interpolation,
Curved interpolation,
Other engineering interpolation.

4. The method according to claim 1, wherein the said object-oriented three-dimensional polygons comprising two-dimensional polygons and object-oriented dots (DOTs).

5. The method according to claim 4, wherein the said two-dimensional polygons are plane projection of the said three-dimensional polygons.

6. The method according to claim 4, wherein the said object-oriented dots (DOTs) are placed along the two-dimensional polygons to define and represent elevations and vertical alignments of the three-dimensional polygons.

7. The method according to claim 4, wherein the said object-oriented dots (DOTs) further comprising data and “methods” in an object-oriented CAD environment.

8. The method according to claim 7, wherein the said data further comprising:
Data defining the location of vertical tangent intersections and grade breaks,
Data defining the elevations at vertical tangent intersections and grade breaks,
Data defining the vertical curves,
Other data.

9. The method according to claim 7, wherein the said “methods” further comprising:
“Methods” defining form and calculation of vertical curves,
“Methods” defining elevation relationships among DOTs,
“Methods” defining other relationships among DOTs,
Other “methods”.

10. One application, of the method according to claim 1, as a design framework for computer-aided design of civil engineering objects comprising the steps of:
Developing two-dimensional polygons to define and represent the plan layout and horizontal alignments of the engineering objects,
Placing the DOTs along the two-dimensional polygons to define the elevations and vertical alignments of the engineering objects,
Establishing and specifying the design data and the “methods” for the DOTs,
Performing calculations, analysis, adjustments, and optimizations to the design alternatives to final completion.
Producing engineering plans and documentations.
